(19) United States
(12) Patent Application Publication
(10) Pub. No.: US 2022/0128075 A1
(43) Pub. Date: Apr. 28, 2022

(54) PANEL JOINT STRUCTURE

(71) Applicant: Mazda Motor Corporation, Hiroshima (JP)

(72) Inventors: Mitsuru WAKABAYASHI, Aki-gun (JP); Koji MIYAMOTO, Aki-gun (JP); Takayuki NAKAMAE, Aki-gun (JP); Noriyuki KAWAI, Aki-gun (JP); Teppei OE, Aki-gun (JP); Hiroki KIMURA, Aki-gun (JP); Kenichi YAMAMOTO, Aki-gun (JP); Koki KAGIMOTO, Aki-gun (JP)

(73) Assignee: Mazda Motor Corporation, Hiroshima (JP)

(21) Appl. No.: 17/500,949

(22) Filed: Oct. 14, 2021

(30) Foreign Application Priority Data
Oct. 22, 2020 (JP) 2020-177556

(51) Int. Cl. F16B 11/00; F16B 5/08

(52) U.S. Cl. CPC F16B 11/006; B62D 25/00; F16B 5/08

(57) ABSTRACT

A panel joint structure suppresses stress concentration on a flange corner section-side end-portion of an adhesive during application of a peeling load. A first panel member includes a panel body section, a corner section, and a first flange section. A second panel member is arranged to oppose the first flange section. A joint section joins the first flange section and the second panel member in a contact state thereof, and an adhesive continuously provided in a longitudinal direction of the corner section adheres the first flange section to the second panel member. The first panel member includes a load transmission section near a joint section, and the load transmission section is provided between the panel body section and the first flange section, and an angle θ2 thereof that is defined with the panel body section is larger than an angle θ1 defined by the panel body section and a portion in a short direction of the first flange section. A flange distal end-side end-portion of the load transmission section in the short direction of the flange section is disposed in a region between a corner section-side end-portion and a distal end-side end-portion of the joint section in the short direction of the first flange section.

### CROSS-REFERENCE TO RELATED APPLICATION

This application claims priority from Japanese Application No. 2020-177556, filed on Oct. 22, 2020, the contents of which are incorporated by reference herein in its entirety.

### TECHNICAL FIELD

The present disclosure relates to a panel joint structure, in detail, a panel joint structure that includes: a first panel member including a panel body section and a first flange section that extends from the panel body section via a corner section; and a second panel member that is arranged to oppose the first flange section and that fixedly joins the first flange section of the first panel member and the second panel member by a joint section and an adhesive.

### BACKGROUND

Conventionally, in a joint technique (for example, weld bonding) of a flange section using both of adhesion by an adhesive and a joint section produced by spot welding or the like, in order to reliably guarantee joint strength of the adhesive, it is beneficial to form an adhesive application space capable of securing a sufficient thickness of the adhesive while providing the joint section as disclosed in Patent document 1.

Meanwhile, when the sufficient thickness of the adhesive is secured and a peeling load is applied to the adhesive due to a repeated load, a stress concentrated portion is generated in the adhesive, which possibly serves as an origin of a crack.

Once the adhesive cracks, a crack growth speed of the adhesive is high, and the adhesive no longer contributes to strength. As a result, the stress is concentrated on the joint section (a nugget) by spot welding, and the joint section ruptures.

When such a panel joint structure is adopted for a panel joint structure of an automobile, the peeling load is applied to the adhesive due to the repeated load during normal travel of the vehicle.

Thus, it is desired to suppress the crack from being produced to the adhesive.

JP-A-2006-213262 discloses a structure of providing a raised section, a raised surface of which is parallel with a cabin-side flange, in a corner section of the cabin-side flange and filling a space between the raised section and the other flange, which opposes and abuts this cabin-side flange, with the adhesive.

However, the structure disclosed in JP-A-2006-213262 is insufficient from a perspective of reducing the peeling load on a flange corner section-side end-portion of the adhesive.

### SUMMARY

In view of the above, embodiments of the present disclosure provide a panel joint structure capable of suppressing stress concentration on a flange corner section-side end-portion of an adhesive during application of a peeling load.

According to one embodiment, a panel joint structure may be provided with: a first panel member that includes a panel body section and a first flange section extending from the panel body section via a corner section; a second panel member that is arranged to oppose the first flange section; a joint section that joins the first flange section and the second panel member in a state where the first flange section and the second panel member contact each other; and an adhesive that is continuously provided along a longitudinal direction of the corner section and adheres the first flange section and the second panel member. The first panel member may include a load transmission section near the joint section, and the load transmission section may be provided between the panel body section and the first flange section and may be set such that an angle defined with the panel body section is larger than an angle defined by the panel body section and a portion in a short direction of the first flange section. In the short direction of the first flange section, a flange distal end-side end-portion of the load transmission section in the short direction of the flange section may be located in a region between a corner section-side end-portion of the joint section and a flange distal end-side end-portion of the joint section in the short direction of the flange section.

Embodiments of the above-described panel member may include a metal member and fiber reinforced plastic, and also includes joining of the same materials, such as steel plates or aluminum plates, and joining of different materials, such as joining of the steel plate and the aluminum plate.

In addition, embodiments of the above-described joint section may include machine joining, that is, joining and one-sided machine joining using a bolt, a nut, a rivet, and a self-piercing rivet (a so-called SPR), and also includes spot welding as resistance welding, friction stir joint welding, and laser welding.

Furthermore, embodiments of the above-described corner section are not limited to a corner section in which the panel body section and the first flange section cross each other at a right angle. In order to enable a molding process, the corner section may include a corner section in which the panel body section and the first flange section are coupled to each other via a curved portion (a so-called rounded portion).

The above configuration has the following effects in embodiments of the disclosure.

By providing the load transmission section, a peeling load that is applied to the corner section-side end-portion of the adhesive may be transmitted from the panel body section to the flange distal end-side end-portion of the load transmission section via the load transmission section. In this way, it is possible to reduce the load that is applied to the corner section-side end-portion of the adhesive. Here, the peeling load means a peeling load in a direction to separate the first flange section and the second panel member from each other.

In addition, the flange distal end-side end-portion of the load transmission section may serve as an origin of deformation, and this origin of deformation may be located near the joint section. Thus, it is possible to diffuse the load to the joint section and to thereby reduce the peeling load that is applied to the corner section-side end-portion of the adhesive.

Therefore, it is possible to suppress stress concentration on the flange corner section-side end-portion of the adhesive during application of the peeling load in embodiments of the disclosure. That is, it is possible to diffuse the peeling load to the joint section via the load transmission section and to thereby reduce the load that is applied to the corner section-side end-portion of the adhesive.

In embodiments of the present disclosure, the plural joint sections may be provided at spaced intervals in a longitudinal direction of the first flange section, and the flange distal end-side end-portion of the load transmission section is provided on an imaginary line that connects central portions of the joint sections, each of which is adjacent to the load transmission section in the longitudinal direction of the flange section.

With the above configuration, it is possible to reliably transmit the load to the joint sections and to thereby diffuse the load.

In embodiments of the present disclosure, the second panel member may be provided with a second flange section that extends from a second panel body section via a second corner section. The second flange section may be arranged to oppose the first flange section. The second panel member may include a second load transmission section near the joint section. The second load transmission section may be provided between the second panel body section and the second flange section and may be set such that an angle defined with the second panel body section is larger than an angle defined by the second panel body section and a portion in a short direction of the second flange section. A flange distal end-side end-portion of the second load transmission section in the short direction of the flange section and the flange distal end-side end-portion of the load transmission section in the first panel member may be provided at substantially the same positions.

With the above configuration, the peeling load that is applied to the second panel member may be also transmitted to the flange distal end-side end-portion of the second load transmission section. When the flange distal end-side end-portion of the load transmission section in the first panel member and the flange distal end-side end-portion of the second load transmission section in the second panel member are provided at substantially the same positions, it is possible to concentrate the stress on a point. As a result, it is possible to reliably diffuse the load to the joint section.

In embodiments of the present disclosure, the load transmission section is formed by a bead, and an internal space of the bead is filled with the adhesive.

With the above configuration, not only the corner section but also the internal space of the bead may be filled with the adhesive. Therefore, it is possible to suppress the stress concentration on the corner section-side end-portion of the adhesive.

In embodiments of the present disclosure, each of the load transmission section and the second load transmission section may be formed by a bead, and an internal space of each of the beads is filled with the adhesive.

With the above configuration, in the configuration that the first panel member and the second panel member respectively include the load transmission section and the second load transmission section formed by the beads, not only the corner section but also the internal space of each of the beads may be filled with the adhesive. Therefore, it is possible to suppress the stress concentration on the corner section-side end-portion of the adhesive and to improve joint strength by the adhesive.

In embodiments of the present disclosure, a flange distal end-side end-portion of the adhesive in the internal space of the bead is provided in a region between a corner section-side end-portion of the joint section and the flange distal end-side end-portion of the joint section in the short direction of the flange section.

With the above configuration, the flange distal end-side end-portion, in which a thickness of the adhesive is reduced, is provided in the above range. Thus, the following effects can be exerted.

In embodiments of the disclosure, the flange distal end-side end-portion of the adhesive separates from the panel body section, which is applied with the load, to the flange distal end-side in the short direction of the flange section. In addition, the flange distal end-side end-portion is likely to be deformed since bending moment that is applied thereto is large. Since this flange distal end-side end-portion, which is likely to be deformed, is provided in the region, the region, which corresponds to the joint section, in the load transmission section is likely to be deformed, and the load can be diffused to the joint section.

In embodiments of the present disclosure, the bead may include an inclined surface that is inclined in a direction toward the second panel member as being stretched toward a distal end-side direction in the short direction of the first flange section, and the inclined surface may couple the panel body section and the first flange section of the first panel member.

With the above configuration, a component (a flange perpendicular component) of the peeling load in a perpendicular direction to the first flange section may be reduced by the inclined surface. In this way, it is possible to reduce the peeling load that is applied to the corner section-side end-portion of the adhesive.

For example, in the inclined surface, the component (the flange perpendicular component) in the perpendicular direction to the first flange section can be broken down into a component force in a direction along the inclined surface and a component force in an orthogonal direction to the inclined surface. The component force in the orthogonal direction to the inclined surface is an actual peeling load that is applied to the adhesive. This component force in the orthogonal direction to the inclined surface is smaller than the peeling load, which is applied to the first panel member. Therefore, it is possible to reduce the peeling load that is applied to the corner section-side end-portion of the adhesive.

Embodiments of the present disclosure have an effect capable of suppressing stress concentration on the flange corner section-side end-portion of the adhesive during application of the peeling load.

### BRIEF DESCRIPTION OF THE DRAWINGS

FIG. 1 is a perspective view illustrating a panel joint structure in embodiments of the present disclosure.

FIG. 2 is an enlarged perspective view of a main section in FIG. 1.

FIG. 3(a) is a cross-sectional view that is taken along line A-A in FIG. 2, and FIG. 3(b) is a cross-sectional view that is taken along line B-B in FIG. 2.

FIG. 4 is a cross-sectional view that is taken along line C-C in FIG. 2.

FIG. 5 is a perspective view illustrating another embodiment of the panel joint structure.

FIG. 6 is a perspective view illustrating further another embodiment of the panel joint structure.

FIG. 7 is a cross-sectional view that is taken along line D-D in FIG. 6.

FIG. 8 is a perspective view illustrating yet another embodiment of the panel joint structure.

FIG. 9 is a perspective view illustrating an embodiment in which the panel joint structure is adopted for a front body structure of a vehicle.

### DETAILED DESCRIPTION

In embodiments of the disclosure, a purpose of suppressing stress concentration on a flange corner section-side end-portion of an adhesive during application of a peeling load is achieved by such a configuration that includes: a first panel member including a panel body section and a first flange section extending from the panel body section via a corner section; a second panel member that is arranged to oppose the first flange section; a joint section that joins the first flange section and the second panel member in a state where the first flange section and the second panel member contact each other; and an adhesive that is continuously provided along a longitudinal direction of the corner section and adheres the first flange section and the second panel member, in which the first panel member includes a load transmission section near the joint section, the load transmission section being provided between the panel body section and the first flange section and being set such that an angle defined with the panel body section is larger than an angle defined by the panel body section and a portion in a short direction of the first flange section, and in which, in the short direction of the first flange section, a flange distal end-side end-portion of the load transmission section in the short direction of the flange section is provided to be located in a region between a corner section-side end-portion of the joint section and the flange distal end-side end-portion of the joint section in the short direction of the flange section.

### First Embodiment

A detailed description will be made on an embodiment of the present disclosure with reference to the drawings.

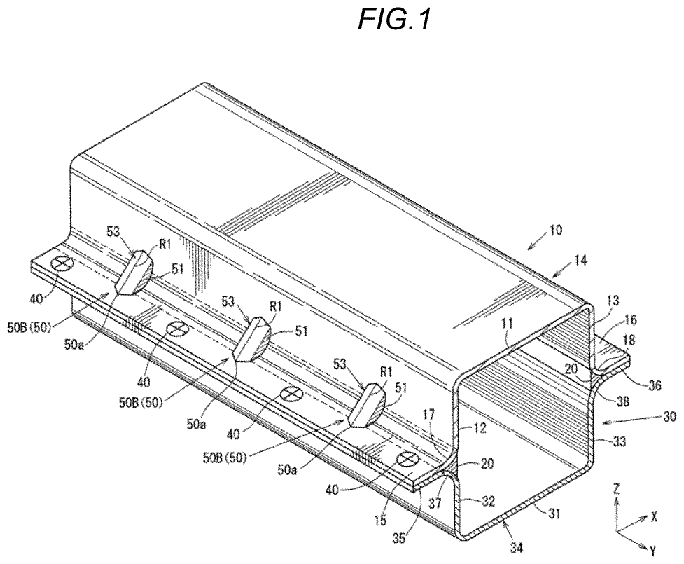

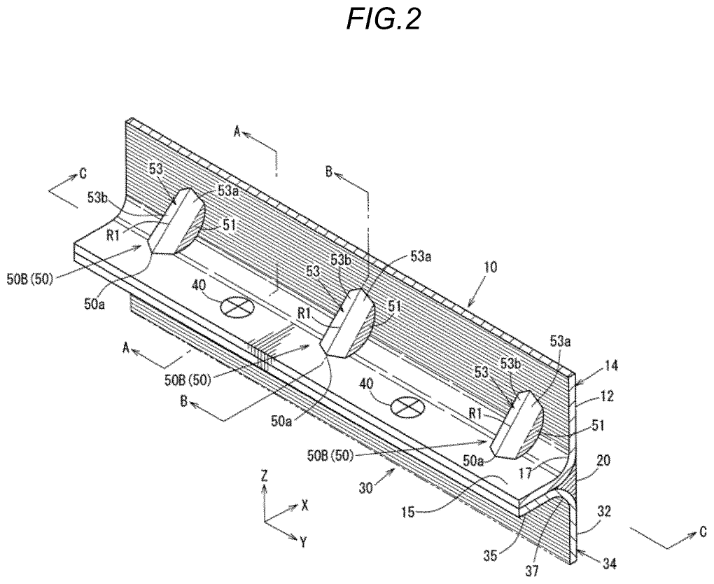

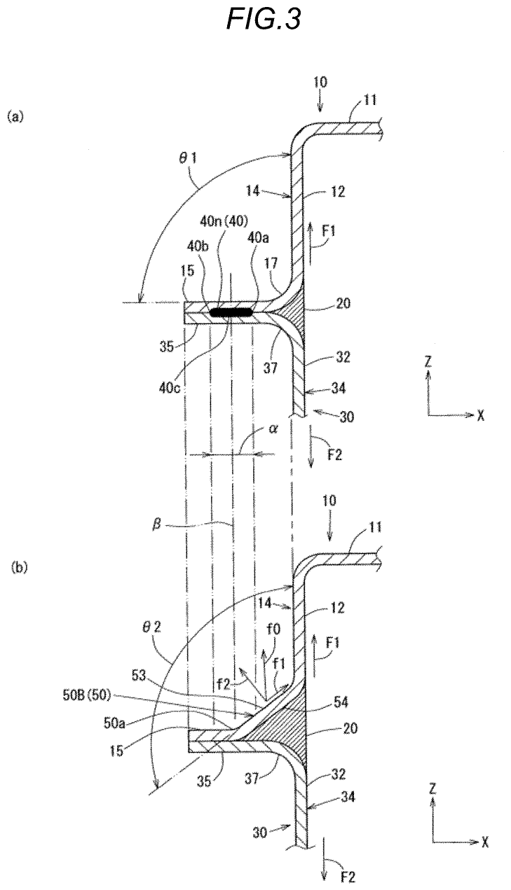

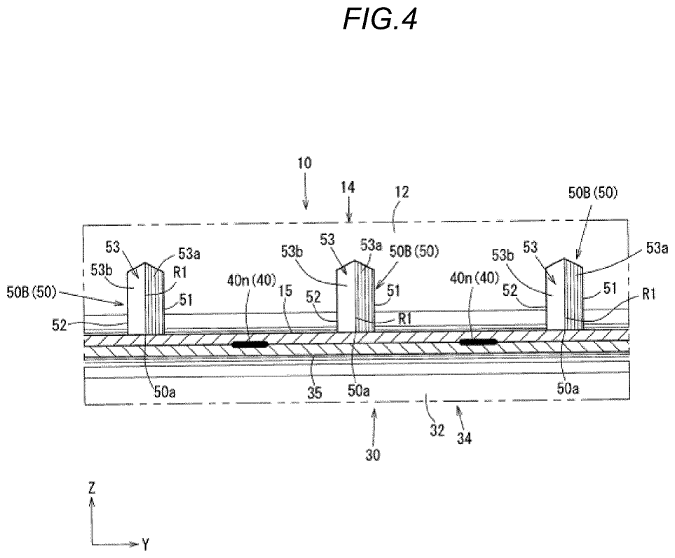

The drawings each illustrate a panel joint structure. FIG. 1 is a perspective view illustrating the panel joint structure, FIG. 2 is an enlarged perspective view of a main section in FIG. 1, FIG. 3(a) is a cross-sectional view that is taken along line A-A in FIG. 2, FIG. 3(b) is a cross-sectional view that is taken along line B-B in FIG. 2, and FIG. 4 is a cross-sectional view that is taken along line C-C in FIG. 2.

In the drawings, an arrow X indicates a short direction of first flange sections 15, 16, an arrow Y indicates a longitudinal direction of the first flange sections 15, 16, and an arrow Z indicates a direction that is orthogonal to each of the X-direction and the Y-direction.

As illustrated in FIG. 1, this panel joint structure includes a first panel member 10 and a second panel member 30.

On a cross section that is defined by an XZ-plane (a coordinate plane), the first panel member 10 includes: a first side wall 11 that extends in the X-direction; and a second side wall 12 and a third side wall 13, each of which extends in the Z-direction from respective one of one end-portion (a left end-portion in FIG. 1) and the other end-portion (a right end-portion in FIG. 1) of this first side wall 11. The second side wall 12 and the third side wall 13 oppose each other, and the above-described side walls 11, 12, 13 constitute a panel body section 14.

In addition, the first flange sections 15, 16 are integrally formed with the above-described second side wall 12 and third side wall 13, respectively, and respectively extend outward from end-portions of the second side wall 12 and the third side wall 13 on opposite sides from end-portions on the first side wall 11 side. The panel body section 14 and the first flange sections 15, 16 constitute a section having a hat-shaped cross section.

Furthermore, a curved corner section 17 is formed between the first flange section 15 on one side and one side (a lower side in FIG. 1) of the second side wall 12, the other side (an upper side in FIG. 1) of which is coupled to the first side wall 11.

Similarly, a curved corner section 18 is also formed between the first flange section 16 on the other side and one side (a lower side in FIG. 1) of the third side wall 13, the other side (an upper side in FIG. 1) of which is coupled to the first side wall 11.

That is, the first flange section 15 on the one side extends outward from the second side wall 12 of the panel body section 14 via the corner section 17. Meanwhile, the first flange section 16 on the other side extends outward from the third side wall 13 of the panel body section 14 via the corner section 18. Here, the above-described first panel member 10 extends in the Y-direction that is the longitudinal direction of the first flange sections 15, 16.

Meanwhile, on the cross section that is defined by the XZ-plane (the coordinate plane), the above-described second panel member 30 includes: a first side wall 31 that extends in the X-direction; and a second side wall 32 and a third side wall 33, each of which extends in the Z-direction from respective one of one end-portion (a left end-portion in FIG. 1) and the other end-portion (a right end-portion in FIG. 1) of this first side wall 31. The second side wall 32 and the third side wall 33 oppose each other, and the above-described side walls 31, 32, 33 constitute a second panel body section 34.

In addition, second flange sections 35, 36 are integrally formed with the above-described second side wall 32 and third side wall 33, respectively, and respectively extend outward from end-portions of the second side wall 32 and the third side wall 33 on opposite sides from the end-portions on the first side wall 31 side. The second panel body section 34 and the second flange sections 35, 36 constitute a portion having the hat-shaped cross section.

As illustrated in FIG. 1, the first side wall 11 of the first panel member 10 and the first side wall 31 of the second panel member 30 oppose each other in a state of being separated from each other in the Z-direction.

Furthermore, a curved second corner section 37 is formed between the second flange section 35 on the one side and one side (an upper side in FIG. 1) of the second side wall 32, the other side (a lower side in FIG. 1) of which is coupled to the first side wall 31.

Similarly, a curved second corner section 38 is also formed between the second flange section 36 on the other side and one side (an upper side in FIG. 1) of the third side wall 33, the other side (a lower side in FIG. 1) of which is coupled to the first side wall 31.

That is, the second flange section 35 on the one side extends outward from the second side wall 32 of the second panel body section 34 via the second corner section 37. Meanwhile, the second flange section 36 on the other side extends outward from the third side wall 33 of the second panel body section 34 via the second corner section 38. Here, the above-described second panel member 30 extends in the Y-direction that is a longitudinal direction of the second flange sections 35, 36.

As illustrated in FIG. 1, the second panel member 30 is arranged to oppose the first flange sections 15, 16 of the first panel member 10. In detail, the second flange sections 35, 36 on the one side and the other side of the second panel member 30 are arranged to respectively oppose the first flange sections 15, 16 on the one side and the other side of the first panel member 10 in a state of respectively contacting the first flange sections 15, 16.

As illustrated in FIG. 1, a joint section 40 is provided to join the first flange section 15 of the first panel member 10 and the second flange section 35 of the second panel member 30 in a state where the first flange section 15 and the second flange section 35 contact each other. Also, on the other side, the joint section 40 is provided to join the first flange section 16 and the second flange section 36 in a state where the first flange section 16 and the second flange section 36 contact each other. However, the joint section on the other side is not illustrated.

As illustrated in FIG. 1, the plural above-described joint sections 40 are provided at specified intervals in the longitudinal direction of the flange sections 15, 35, that is, in the Y-direction.

In this embodiment, each of the first panel member 10 and the second panel member 30 is formed of a steel plate. Thus, each of the above-described joint sections 40 is formed by a nugget (a molten-solidified section) 40n (see FIG. 3 and FIG. 4) by spot welding.

As illustrated in FIG. 1 to FIG. 3, an adhesive 20 is continuously provided along the longitudinal direction (the Y-direction) in portions between the opposing corner sections 17, 37 and the opposing corner sections 18, 38. The adhesive 20 adheres each of the first flange sections 15, 16 and the second panel member 30.

In this first embodiment, it is configured that the adhesive 20 adheres a portion on the corner section 17 side of the opposing first flange section 15 to a portion on the corner section 37 side of the opposing second flange section 35 and that the adhesive 20 adheres a portion on the corner section 18 side of the opposing first flange section 16 to a portion on the corner section 38 side of the opposing second flange section 36.

A structure adhesive is used as the above-described adhesive 20, and a representative example thereof is an epoxide-based adhesive. However, the adhesive 20 is not limited to the epoxide-based adhesive. Any of the structure adhesives such as an urethane-based adhesive, an acrylic adhesive, or a modified silicone-based adhesive may be used. In addition, any type of the adhesives can be used as long as such an adhesive is suitable to join a vehicle body.

As illustrated in FIG. 1 to FIG. 4, the above-described first panel member 10 is provided with a load transmission section 50 in a manner to be located near each of the joint sections 40.

The above-described load transmission section 50 is formed by a bead 50B. This load transmission section 50 (the bead 50B) is provided between the second side wall 12 and the first flange section 15 of the panel body section 14.

As illustrated in FIG. 3(b), an inclined surface 53, which will be described below, of the above-described load transmission section 50 is set such that an angle θ2 defined with the second side wall 12 of the panel body section 14 is larger than an angle θ1 (see FIG. 3(a)) defined by the second side wall 12 and a portion in the short direction of the first flange section 15 in the panel body section 14.

In this first embodiment, the angle θ2, which is defined by the inclined surface 53 of the load transmission section 50 and the second side wall 12, is set as an obtuse angle, more specifically, at 128 degrees. Meanwhile, the angle θ1, which is defined by the portion in the short direction of the first flange section 15 and the second side wall 12, is set at 90 degrees. That is, the angles θ1, θ2 are set such that a relational expression θ2>θ1 is satisfied. However, each of these angles θ1, θ2 is not limited to have the exemplified numerical value.

As illustrated in FIG. 2 and FIG. 4, the above-described load transmission section 50 (the bead 50B) includes: a pair of vertical walls 51, 52 separated in the Y-direction; and the inclined surface 53 that couples these vertical walls 51, 52. The inclined surface 53 is inclined in a direction toward the second flange section 35 of the second panel member 30 as being stretched toward a distal end-side direction in the short direction of the first flange section 15.

The above-described inclined surface 53 has two slant sections 53a, 53b that are inclined in opposite directions. Between these slant sections 53a, 53b, a ridgeline R1 is formed to be inclined in the direction toward the second flange section 35 as being stretched toward the distal end-side direction of the first flange section 15.

The thus-formed load transmission section 50 (the bead 50B) is provided between the second side wall 12 and the first flange section 15 of the panel body section 14. In the Y-direction, the load transmission section 50 is provided between two each of the plural joint sections 40, 40.

As illustrated in FIG. 3, in the short direction of the first flange section 15, that is, in the X-direction, an end-portion 50a on a flange distal end-side of the above-described load transmission section 50 in the short direction of the flange section (hereinafter, simply described as a flange distal end-side end-portion 50a) is provided to be located in a region α (in detail, in an area on an extended line) between a corner section-side end-portion 40a of the joint section 40 and an end-portion 40b on the flange distal end-side of the joint section 40 in the short direction of the flange section (hereinafter, simply described as a distal end-side end-portion 40b).

In this embodiment, the flange distal end-side end-portion 50a of the load transmission section 50 is provided on an imaginary line β that connects central portions 40c of the nuggets 40n as the joint sections 40.

When the above-described load transmission section 50 is provided just as described, a peeling load (at least one of loads F1, F2 illustrated in FIG. 3, in particular, the load F1) that is applied to a corner section-side end-portion of the adhesive 20 is transmitted from the panel body section 14 to the flange distal end-side end-portion 50a of the load transmission section 50 via the load transmission section 50. In this way, it is configured to reduce the load that is applied to the corner section-side end-portion of the adhesive 20.

In addition, the flange distal end-side end-portion 50a of the load transmission section 50 serves as an origin of deformation, and this origin of deformation is located near the joint section 40. In this way, it is configured to be able to diffuse the load to the joint section 40 and to thereby reduce the peeling load that is applied to the corner section-side end-portion of the adhesive 20.

In other words, the flange distal end-side end-portion 50a, which serves as the origin of deformation, in the load transmission section 50 is restrained by the joint sections 40, 40 from both sides in the Y-direction. In such a state, when the origin of deformation moves, the load is transmitted to the nuggets 40n as the joint sections 40. In this way, it is configured to diffuse the load to the joint sections 40 and to thereby reduce the peeling load that is applied to the corner section-side end-portion of the adhesive 20.

As a result, it is possible to suppress stress concentration on the flange corner section-side end-portion of the adhesive 20 during application of the peeling load. That is, it is configured to diffuse the peeling load to the joint section 40 via the load transmission section 50 and to thereby reduce the load that is applied to the corner section-side end-portion of the adhesive 20.

In particular, the panel joint structure of this embodiment is configured to provide the flange distal end-side end-portion 50a of the load transmission section 50 on the imaginary line β, which connects the central portions 40c of the joint sections 40, each of which is adjacent to the load transmission section 50 in the longitudinal direction of the flange section, and to thereby reliably transmit the load to the joint sections 40, so as to diffuse the load.

As illustrated in FIG. 2 and FIG. 3, the adhesive 20 is seamlessly and continuously provided along the longitudinal direction of the corner sections 17, 37, that is, the Y-direction. In addition, an internal space of the load transmission section 50 that is formed by the bead 50B, that is, an internal space 54 of the bead 50B is filled with the adhesive 20.

Just as described, it is configured to fill not only the corner sections 17, 37 but also the internal space 54 of the bead 50B with the above-described adhesive 20 and to thereby suppress the stress concentration on the corner section-side end-portion of the adhesive 20.

In particular, as illustrated in FIG. 3(b), a flange distal end-side end-portion of the adhesive 20 in the internal space 54 of the above-described bead 50B is provided in the region a between the corner section-side end-portion 40a of the joint section 40 and the flange distal end-side end-portion 40b of the joint section 40 in the short direction of the flange section. In this embodiment, the entire internal space 54 of the bead 50B is filled with the adhesive 20.

As illustrated in FIG. 3(b), the flange distal end-side end-portion of the adhesive 20 separates from the panel body section, which is applied with the load, to the flange distal end-side in the short direction of the flange section. In addition, the flange distal end-side end-portion of the adhesive 20 is likely to be deformed since bending moment that is applied thereto is large. This flange distal end-side end-portion, which is likely to be deformed, is provided in a range that corresponds to the region α in the longitudinal direction of the flange section. In this way, a region corresponding to the joint section 40 in the load transmission section 50 is likely to be deformed, and the load is diffused to the joint section 40.

As illustrated in the embodiment of FIG. 1 to FIG. 3, the above-described bead 50B includes the inclined surface 53. With this inclined surface 53, the second side wall 12 and the first flange section 15 in the panel body section 14 of the first panel member 10 are coupled to each other obliquely.

In this way, it is configured to reduce a component of the peeling load F1 in a perpendicular direction to the first flange section 15 by the inclined surface 53 and to thereby reduce the peeling load that is applied to the corner section-side end-portion of the adhesive 20.

In detail, as illustrated in FIG. 3(b), in the inclined surface 53, a component in the perpendicular direction to the first flange section 15 (a flange perpendicular component) f0 can be broken down into a component force f1 in a direction along the inclined surface 53 and a component force f2 in an orthogonal direction to the inclined surface 53. The component force f2 in the orthogonal direction to the inclined surface 53 is the actual peeling load that is applied to the adhesive 20. The component force f2 in the orthogonal direction to the inclined surface 53 is smaller than the peeling load F1, which is applied to the first panel member 10. In this way, the panel joint structure of this embodiment is configured to reduce the peeling load that is applied to the corner section-side end-portion of the adhesive 20.

As described above, the panel joint structure in the first embodiment, which is illustrated in FIG. 1 to FIG. 4, is provided with: the first panel member 10 including the panel body section 14 and the first flange section 15 that extends from the panel body section 14 via the corner section 17; the second panel member 30 that is arranged to oppose the first flange section 15; the joint section 40 that joins the first flange section 15 and the second panel member 30 in the state where the first flange section 15 and the second panel member 30 contact each other; and the adhesive 20 that is continuously provided along the longitudinal direction of the corner section 17 and adheres the first flange section 15 to the second panel member 30. The first panel member 10 includes the load transmission section 50 near the joint section 40. The load transmission section 50 is provided between the panel body section 14 and the first flange section 15 and is set such that the angle θ2 defined with the panel body section 14 (in particular, see the second side wall 12) is larger than the angle θ1 defined by the panel body section 14 and the portion in the short direction of the first flange section 15. In the short direction of the first flange section 15, the flange distal end-side end-portion 50a of the load transmission section 50 in the short direction of the flange section is provide to be located in the region α (in detail, in the area on the extended line of the region α) between the corner section-side end-portion 40a of the joint section 40 and the flange distal end-side end-portion 40b of the joint section 40 in the short direction of the flange section (see FIG. 1 to FIG. 4).

Referring to FIGS. 3(a) and 3(b), for example, angle θ2 may be defined by the angle between inclined surface 53 of bead 50B and the second side wall 12 of panel body section 14. Angle θ1 may be defined by the angle between the first flange section 15 and the second side wall 12 of panel body section 14. Angle θ2 may be greater than angle θ1.

This configuration has the following effects.

Since the load transmission section 50 is provided, the peeling load that is applied to the corner section-side end-portion of the adhesive 20 is transmitted from the panel body section 14 to the flange distal end-side end-portion 50a of the load transmission section 50 via the load transmission section 50. In this way, it is possible to reduce the load that is applied to the corner section-side end-portion of the adhesive 20.

In addition, the flange distal end-side end-portion 50a of the load transmission section 50 serves as the origin of deformation, and this origin of deformation is located near the joint section 40. Therefore, it is possible to diffuse the load to the joint section 40 and to thereby reduce the peeling load that is applied to the corner section-side end-portion of the adhesive 20.

As a result, it is possible to suppress the stress concentration on the flange corner section-side end-portion of the adhesive 20 during the application of the peeling load. That is, it is possible to diffuse the peeling load to the joint section 40 via the load transmission section 50 and to thereby reduce the load that is applied to the corner section-side end-portion of the adhesive 20.

In addition, in an embodiment of the present disclosure, the plural joint sections 40 are provided at the spaced intervals in the longitudinal direction of the first flange section 15, and the flange distal end-side end-portion 50a of the load transmission section 50 is provided on the imaginary line β that connects the central portions 40c of the joint sections 40, each of which is adjacent to the load transmission section 50 in the longitudinal direction of the flange section (see FIG. 3).

With this configuration, it is possible to reliably transmit the load to the joint sections 40 and to thereby diffuse the load.

Furthermore, in an embodiment of the present disclosure, the load transmission section 50 is formed by the bead 50B, and the internal space 54 of the bead 50B is filled with the adhesive 20 (see FIG. 3(b)).

With this configuration, not only the corner section 17 but also the internal space 54 of the bead 50B are filled with the adhesive 20. Therefore, it is possible to suppress the stress concentration on the corner section-side end-portion of the adhesive 20.

Moreover, in an embodiment of the present disclosure, the flange distal end-side end-portion of the adhesive 20 in the internal space 54 of the bead 50B is provided in the region α between the corner section-side end-portion 40a of the joint section 40 and the flange distal end-side end-portion 40b of the joint section 40 in the short direction of the flange section (see FIG. 3).

With this configuration, the flange distal end-side end-portion, in which the thickness of the adhesive 20 is reduced, is provided in the range of the region α. Thus, the following effects can be exerted.

The flange distal end-side end-portion of the adhesive 20 separates from the panel body section, which is applied with the load, to the flange distal end-side in the short direction of the flange section. In addition, the flange distal end-side end-portion of the adhesive 20 is likely to be deformed since the bending moment that is applied thereto is large. This flange distal end-side end-portion, which is likely to be deformed, is provided in the above range. In this way, the region α, which corresponds to the joint section 40, in the load transmission section 50 is likely to be deformed, and the load can be diffused to the joint section 40.

In addition, in an embodiment of the present disclosure, the bead 50B includes the inclined surface 53 that is inclined in the direction toward the second panel member 30 as being stretched toward the distal end-side direction in the short direction of the first flange section 15. The panel body section 14 and the first flange section 15 of the first panel member 10 are coupled by the inclined surface 53 (see FIG. 1 to FIG. 4).

With this configuration, it is possible to reduce the component (the flange perpendicular component) of the peeling load F1 in the perpendicular direction to the first flange section 15 by the inclined surface 53 and to thereby reduce the peeling load that is applied to the corner section-side end-portion of the adhesive 20.

For example, in the inclined surface 53, the component (the flange perpendicular component) f0 in the perpendicular direction to the first flange section 15 can be broken down into the component force f1 in the direction along the inclined surface 53 and the component force f2 in the orthogonal direction to the inclined surface 53. The component force f2 in the orthogonal direction to the inclined surface 53 is the actual peeling load that is applied to the adhesive 20. This component force f2 in the orthogonal direction to the inclined surface 53 is smaller than the peeling load F1, which is applied to the first panel member 10. Thus, it is possible to reduce the peeling load that is applied to the corner section-side end-portion of the adhesive 20.

### Second Embodiment

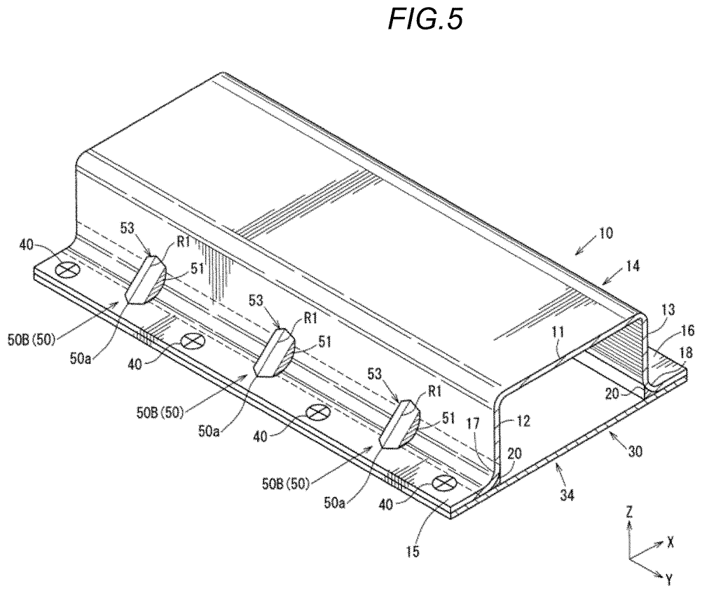

FIG. 5 is a perspective view illustrating another embodiment of the panel joint structure.

Similar to the panel joint structure in the first embodiment, in a panel joint structure in a second embodiment, which is illustrated in FIG. 5, the first panel member 10 is formed to have the hat-shaped cross-section. Meanwhile, a panel body section 34 that is formed of a flat plate material is used for the second panel member 30.

Then, one side portion (a left portion in FIG. 5) and the other side portion (a right portion in FIG. 5) of the panel body section 34 are respectively arranged to oppose the first flange sections 15, 16 of the first panel member 10, and the joint section 40 is provided to join the second panel member 30 and each of the first flange sections 15, 16 in a state where the second panel member 30 and the first flange sections 15, 16 contact each other.

In other words, in this second embodiment, the panel joint structure joins the first panel member 10 having the hat-shaped cross section and the second panel member 30 in a flat plate shape.

Also, in the second embodiment illustrated in FIG. 5, the other configurations including that of the main section, the operation, and the effects are the same as those in the above first embodiment. Thus, in FIG. 5, the same portions as those in the preceding drawings will be denoted by the same reference signs, and the detailed description thereon will not be repeated.

### Third Embodiment

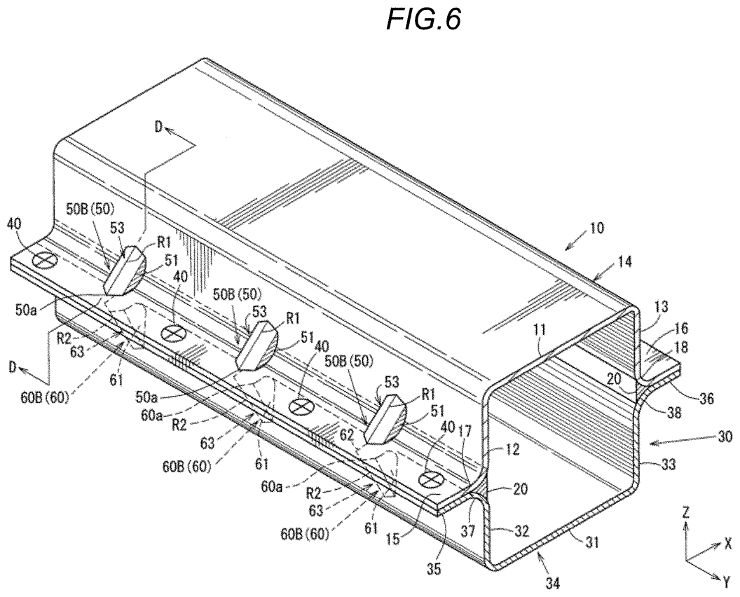

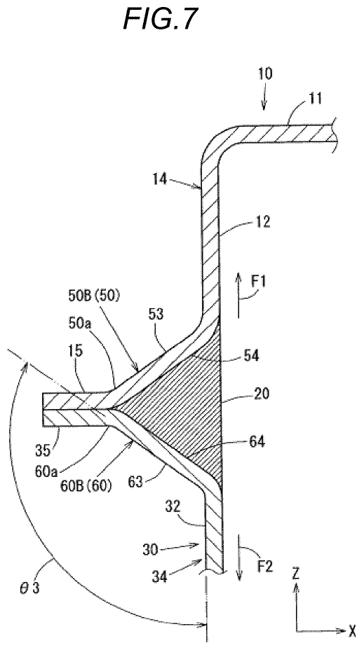

FIG. 6 is a perspective view illustrating further another embodiment of the panel joint structure, and FIG. 7 is a cross-sectional view that is taken along line D-D in FIG. 6.

In this third embodiment illustrated in FIG. 6 and FIG. 7, in addition to the structure in the first embodiment illustrated in FIG. 1 to FIG. 4, a second load transmission section 60, which is formed by a second bead 60B, is also provided on the second panel member 30 side. This second load transmission section 60 is formed to be symmetrical or substantially symmetrical to the load transmission section 50.

That is, as illustrated in FIG. 6 and FIG. 7, the above-described second panel member 30 is provided with the second load transmission section 60 in a manner to be located near the joint section 40.

The above-described second load transmission section 60 is formed by the second bead 60B, and this second load transmission section 60 (the second bead 60B) is provided between the second side wall 32 and the second flange section 35 of the second panel body section 34.

An inclined surface 63, which will be described below, of the above-described second load transmission section 60 is set such that an angle θ3 defined with the second side wall 32 of the second panel body section 34 is larger than an angle (a right angle) defined by the second side wall 32 and a portion in a short direction of the second flange section 35 in the second panel body section 34.

In this third embodiment, the angle θ3, which is defined by the inclined surface 63 of the second load transmission section 60 and the second side wall 32, is set as an obtuse angle, more specifically, at 125 degrees. Meanwhile, the angle, which is defined by the portion in the short direction of the second flange section 35 and the second side wall 32, is set at 90 degrees. However, each of these angles is not limited to have the exemplified numerical value.

As illustrated in FIG. 6 and FIG. 7, the above-described second load transmission section 60 (the second bead 60B) includes: a pair of vertical walls 61, 62 separated in the Y-direction; and the inclined surface 63 that couples these vertical walls 61, 62. The inclined surface 63 is inclined in a direction toward the first flange section 15 of the first panel member 10 as being stretched toward a distal end-side direction in the short direction of the second flange section 35.

The above-described inclined surface 63 has two slant sections that are inclined in opposite directions. Between these slant sections, a ridgeline R2 is formed to be inclined in the direction toward the first flange section 15 as being stretched toward the distal end-side direction in the short direction of the second flange section 35.

The thus-formed second load transmission section 60 (the second bead 60B) is provided between the second side wall 32 and the second flange section 35 of the second panel body section 34. In the Y-direction, the second load transmission section 60 is provided between two each of the plural joint sections 40, 40 in the Y-direction.

In the short direction of the second flange section 35, that is, in the X-direction, a flange distal end-side end-portion 60a of the above-described second load transmission section 60 is provided to be located in the region α (in detail, in the area on the extended line) between the corner section-side end-portion 40a of the joint section 40 and the distal end-side end-portion 40b of the joint section 40.

In this embodiment, the flange distal end-side end-portion 60a of the second load transmission section 60 in the short direction of the flange section is provided on the imaginary line β that connects the central portions 40c of the nuggets 40n as the joint sections 40, each of which is adjacent to the second load transmission section 60 in the longitudinal direction of the flange section (see FIG. 3).

In addition, as illustrated in FIG. 6 and FIG. 7, the flange distal end-side end-portion 60a of the second load transmission section 60 and the flange distal end-side end-portion 50a of the load transmission section 50 in the above-described first panel member 10 are provided at substantially the same positions.

Furthermore, as illustrated in FIG. 7, the load transmission section 50 on the first panel member 10 side and the second load transmission section 60 on the second panel member 30 side are respectively formed by the beads 50B, 60B, and the internal spaces 54, 64 of the beads 50B, 60B continue in the X-direction and the Z-direction. Then, each of these internal spaces 54, 64 is filled with the above-described adhesive 20.

As described above, in the third embodiment illustrated in FIG. 6 and FIG. 7, the second panel member 30 is provided with the second flange section 35 that extends from the second panel body section 34 via the second corner section 37, the second flange section 35 is arranged to oppose the first flange section 15, the second panel member 30 includes the second load transmission section 60 near the joint section 40, the second load transmission section 60 is provided between the second panel body section 34 and the second flange section 35 and is set such that the angle θ3 defined with the second panel body section 34 (see the second side wall 32) is larger than the angle (the right angle) defined by the second panel body section 34 (see the second side wall 32) and the portion in the short direction of the second flange section 35, and the flange distal end-side end-portion 60a of the second load transmission section 60 in the short direction of the flange section and the flange distal end-side end-portion 50a of the load transmission section 50 in the first panel member 10 are provided at substantially the same positions (see FIG. 6 and FIG. 7).

With this configuration, the peeling load F2 that is applied to the second panel member 30 is transmitted to the flange distal end-side end-portion 60a of the second load transmission section 60. Since the flange distal end-side end-portion 50a of the load transmission section 50 in the first panel member 10 and the flange distal end-side end-portion 60a of the second load transmission section 60 in the second panel member 30 are provided at substantially the same positions, it is possible to concentrate the stress on a point. As a result, it is possible to reliably diffuse the load to the joint section 40.

In addition, in this third embodiment, the load transmission section 50 and the second load transmission section 60 are respectively formed by the beads 50B, 60B, and each of the continuous internal spaces 54, 64 of the beads 50B, 60B is filled with the adhesive 20 (see FIG. 7).

With this configuration, in the configuration that the first panel member 10 and the second panel member 30 respectively include the load transmission section 50 and the second load transmission section 60 that are respectively formed by the beads 50B, 60B, not only the corner sections 17, 37 but also the internal spaces 54, 64 of the beads 50B, 60B are filled with the adhesive 20. Thus, it is possible to suppress the stress concentration on the corner section-side end-portion of the adhesive 20 and to improve joint strength by the adhesive 20.

Also, in the third embodiment illustrated in FIG. 6 and FIG. 7, the other configurations, the operation, and the effects are the same as those in the above first embodiment. Thus, in FIG. 6 and FIG. 7, the same portions as those in the preceding drawings will be denoted by the same reference signs, and the detailed description thereon will not be repeated.

### Fourth Embodiment

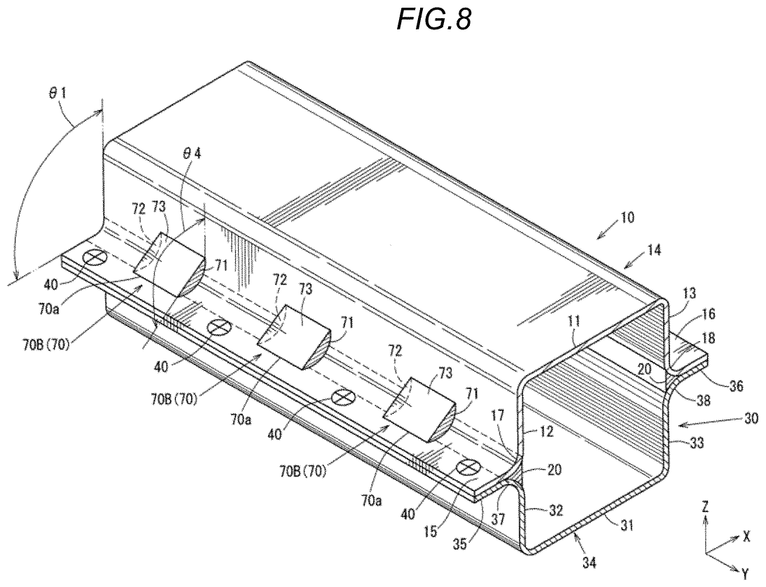

FIG. 8 is a perspective view illustrating further another embodiment of the panel joint structure.

In this fourth embodiment illustrated in FIG. 8, instead of the first embodiment illustrated in FIG. 1, that is, the load transmission section 50 (the bead 50B) having the inclined surface 53 that is formed with the ridgeline R1 at the center of the bead 50B in the Y-direction, a load transmission section 70 having a flat-shaped inclined surface 73 is adopted.

That is, as illustrated in FIG. 8, the above-described first panel member 10 is provided with the load transmission section 70 in the manner to be located near the joint section 40.

The above-described load transmission section 70 is formed by a bead 70B. This load transmission section 70 (the bead 70B) is provided between the second side wall 12 and the first flange section 15 of the panel body section 14.

An inclined surface 73 of the above-described load transmission section 70 is set such that an angle θ4 defined with the second side wall 12 of the panel body section 14 is larger than the angle (the right angle) θ1 defined by the second side wall 12 and the portion in the short direction of the first flange section 15 in the panel body section 14.

In this fourth embodiment, the angle θ4, which is defined by the inclined surface 73 of the load transmission section 70 and the second side wall 12, is set as the obtuse angle. Meanwhile, the angle θ1, which is defined by the portion in the short direction of the first flange section 15 and the second side wall 12, is set at 90 degrees. That is, the load transmission section 70 is formed to satisfy a relational expression θ4>θ1.

As illustrated in FIG. 8, the above-described load transmission section 70 (the bead 70B) includes: a pair of vertical walls 71, 72 separated in the Y-direction; and the flat-shaped inclined surface 73 that couples these vertical walls 71, 72. The inclined surface 73 is inclined in the direction toward the second flange section 35 of the second panel member 30 as being stretched toward the distal end-side direction in the short direction of the first flange section 15.

The thus-formed load transmission section 70 (the bead 70B) is provided between the second side wall 12 and the first flange section 15 of the panel body section 14. In the Y-direction, the load transmission section 70 is provided between two each of the plural joint sections 40, 40.

As illustrated in FIG. 8, in the short direction of the first flange section 15, that is, in the X-direction, a flange distal end-side end-portion 70a of the above-described load transmission section 70 in the short direction of the flange section is provided to be located in the region (in detail, in the area on the extended line) between the corner section-side end-portion of the joint section 40 and the distal end-side end-portion of the joint section 40.

In this embodiment, the flange distal end-side end-portion 70a of the load transmission section 70 is provided on the imaginary line that connects the central portions of the nuggets 40n (see preceding drawings) as the joint sections 40, each of which is adjacent to the load transmission section 70 in the longitudinal direction of the flange section.

In addition, the bead 70B that forms the above-described load transmission section 70 has an internal space, and this internal space is filled with the above-described adhesive 20.

Also, in this fourth embodiment, it is possible to diffuse the peeling load to the above-described joint section 40 via the load transmission section 70 and to thereby reduce the load that is applied to the corner section-side end-portion of the adhesive 20.

Also, in the fourth embodiment illustrated in FIG. 8, the other configurations, the operation, and the effects are the same as those in the above first embodiment. Thus, in FIG. 8, the same portions as those in the preceding drawings will be denoted by the same reference signs, and the detailed description thereon will not be repeated.

### Fifth Embodiment

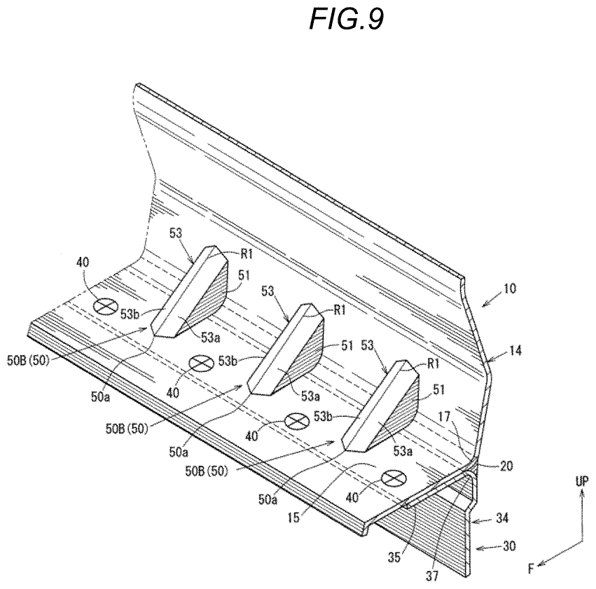

FIG. 9 is a perspective view illustrating an embodiment in which the panel joint structure is adopted for a front body structure of a vehicle.

In this fifth embodiment, the first panel member 10 is an upper dashboard, and the second panel member 30 is a lower dashboard.

The second flange section 35 that extends to the front of the vehicle via the corner section 37 is formed in an upper end-portion of the lower dashboard (the second panel member 30) that separates an engine room (a motor room in a case of an electric vehicle) and a cabin in a vehicle longitudinal direction.

Meanwhile, the first flange section 15 that extends to the front of the vehicle via the corner section 17 is formed at a lower end of the panel body section 14 of the upper dashboard (the first panel member 10).

The joint section 40 is provided to join the second flange section 35 of the lower dashboard (the second panel member 30) and the first flange section 15 of the upper dashboard (the first panel member 10) in the state where the first flange section 15 and the second flange section 35 contact each other.

The plural above-described joint sections 40 are provided at specified intervals in the longitudinal direction of the flange sections 15, 35, that is, in a vehicle width direction.

As illustrated in FIG. 9, the adhesive 20 is continuously provided along the longitudinal direction of the corner section 17 of the upper dashboard (the first panel member 10) and the corner section 37 of the lower dashboard (the second panel member 30), and the adhesive 20 adheres the first flange section 15 to the second flange section 35.

As illustrated in FIG. 9, the load transmission section 50, which is formed by the bead 50B, is provided between the panel body section 14 and the first flange section 15 of the upper dashboard (the first panel member 10). This load transmission section 50 is provided near the joint section 40 in a manner to be located between the plural joint sections 40, 40.

Similar to the above embodiment, the above-described load transmission section 50 has the inclined surface 53 and is formed such that the angle defined by this inclined surface 53 and the panel body section 14 is larger than the angle defined by the portion in the short direction of the first flange section 15 and the panel body section 14.

That is, the angle that is defined by the portion in the short direction of the first flange section 15 and the panel body section 14 is set at approximately 100 degrees, and the angle that is defined by the inclined surface 53 of the load transmission section 50 and the panel body section 14 is set at 134 degrees that is larger than approximately 100 degrees. However, the numerical values of the above angles constitute one example, and the above angles are not limited thereto.

Furthermore, as illustrated in FIG. 9, in the short direction of the first flange section 15, the flange distal end-side end-portion 50a of the above-described load transmission section 50 is provided to be located in the region (in detail, in an extended area that connects the regions of the adjacent joint sections 40, 40) between the corner section-side end-portion of the joint section 40 and the distal end-side end-portion of the joint section 40 in the short direction of the flange section.

In this fifth embodiment, similar to the above embodiment, the flange distal end-side end-portion 50a of the load transmission section 50 is provided on the imaginary line that connects the central portions of the joint sections 40, each of which is adjacent to the load transmission section 50 in the longitudinal direction of the flange section.

In addition, the entire internal space of the bead 50B is filled with the above-described adhesive 20.

As described above, the above configuration is adopted for the upper dashboard (the first panel member 10). Accordingly, during normal travel of the vehicle, it is possible to suppress the stress concentration on the end-portion on the corner section 17 side of the adhesive 20 when a repeated load is applied to the upper dashboard (the first panel member 10) from a top damper in a front suspension.

That is, the peeling load is diffused to the joint section 40 via the above-described load transmission section 50. In this way, it is possible to reduce the load that is applied to the corner section-side end-portion of the adhesive 20.

Also, in this fifth embodiment illustrated in FIG. 9, the other configurations, the operation, and the effects are substantially the same as those in the above embodiment. Thus, in FIG. 9, the same portions as those in the preceding drawings will be denoted by the same reference signs, and the detailed description thereon will not be made.

In FIG. 9, an arrow F indicates a vehicle front direction, and an arrow UP indicates a vehicle upper direction.

In correspondence between the configuration in the present disclosure and the above-described embodiments, the joint section 40 in the present disclosure corresponds to the nugget 40n that is formed by spot welding in the embodiment. However, the joint section 40 may be formed by machine joining, that is, joining and one-sided machine joining using a bolt, a nut, a rivet, a self-piercing rivet (a so-called SPR), furthermore, friction stir joint welding and laser welding.

In the above embodiment, each of the first panel member 10 and the second panel member 30 is formed of the steel plate so as to allow spot welding. The panel members 10, 30 include a metal member and fiber reinforced plastic, and include joining of the same materials, such as the steel plates or aluminum plates, and joining of different materials, such as the steel plate and the aluminum plate.

Furthermore, the corner section 17 is not limited to the corner section in which the panel body section 14 and the first flange section 15 cross each other at the right angle. In order to enable a molding process, the corner section 17 includes a corner section in which the panel body section 14 and the first flange section 15 are coupled to each other via a curved portion (a so-called rounded portion) and a corner section in which the panel body section 14 and the first flange section 15 are coupled to each other via a tapered portion.

In addition, the structure adhesive is used as the above-described adhesive 20, and the representative example thereof is the epoxide-based adhesive. However, the adhesive 20 is not limited to the epoxide-based adhesive. Any of the structure adhesives such as the urethane-based adhesive, the acrylic adhesive, and the modified silicone-based adhesive may be used. In addition, any type of the adhesives can be used as long as such an adhesive is used to join the vehicle body.

The present disclosure is not only limited to the configuration in each of the above-described embodiments but can be implemented in various embodiments.

As discussed above, embodiments of the present disclosure may provide a panel joint structure that includes: the first panel member including the panel body section and the first flange section that extends from the panel body section via the corner section; and the second panel member that is arranged to oppose the first flange section, and that fixedly joins the first flange section of the first panel member and the second panel member by the joint section and the adhesive.

### DESCRIPTION OF REFERENCE SIGNS AND NUMERALS

10 First panel member
14 Panel body section
15 First flange section
17 Corner section
20 Adhesive
30 Second panel member
34 Second panel body section
35 Second flange section
37 Second corner section
40 Joint section
40a Corner section-side end-portion
40b Distal end-side end-portion
40c Central portion
50, 70 Load transmission section
50a, 60a, 70a Flange distal end-side end-portion
50B, 70B Bead
53, 63, 73 Inclined surface
54, 64 Internal space
60 Second load transmission section
60B Second bead

1. A panel joint structure comprising:
a first panel member comprising a panel body section and a first flange section that extends from said panel body section via a corner section;
a second panel member that is arranged to oppose the first flange section;
a joint section that joins the first flange section and the second panel member in a state where the first flange section and the second panel member contact each other; and
an adhesive that is continuously provided along a longitudinal direction of the corner section and adheres the first flange section to the second panel member,
wherein the first panel member comprises a load transmission section near the joint section, the load transmission section being provided between the panel body section and the first flange section and configured such that a first angle defined with the panel body section is larger than a second angle defined by the panel body section and a portion in a short direction of the first flange section, and
wherein, in the short direction of the first flange section, a flange distal end-side end-portion of the load transmission section is disposed in a region between a corner section-side end-portion of the joint section and a flange distal end-side end-portion of said joint section.

2. The panel joint structure according to claim 1, wherein
a plurality of joint sections are provided at spaced intervals in a longitudinal direction of the first flange section, and
the flange distal end-side portion of the load transmission section is provided on an imaginary line that connects central portions of the plurality of joint sections, each of which is adjacent to the load transmission section in the longitudinal direction of the flange section.

3. The panel joint structure according to claim 1, wherein
the second panel member is provided with a second flange section that extends from a second panel body section via a second corner section,
said second flange section is arranged to oppose the first flange section,
the second panel member comprises a second load transmission section near the joint section, the second load transmission section being provided between the second panel body section and the second flange section and configured such that a third angle defined with the second panel body section is larger than a fourth angle defined by the second panel body section and a portion in a short direction of the second flange section, and
a flange distal end-side end-portion of the second load transmission section in the short direction of the second flange section and the flange distal end-side end-portion of the load transmission section in the first panel member are provided at substantially the same positions.

4. The panel joint structure according to claim 1, wherein
the load transmission section is formed by a bead, and an internal space of said bead is filled with the adhesive.

5. The panel joint structure according to claim 3, wherein
each of the load transmission section and the second load transmission section is formed by a bead, and internal space of each of the beads is filled with the adhesive.

6. The panel joint structure according to claim 4, wherein
a flange distal end-side end-portion of the adhesive in the internal space of the bead is provided in a region between a corner section-side end-portion of the joint section and the flange distal end-side end-portion of said joint section in the short direction of the flange section.

7. The panel joint structure according to claim 4, wherein
the bead comprises an inclined surface that is inclined in a direction toward the second panel member as being stretched toward a distal end-side direction in the short direction of the first flange section, and
said inclined surface couples the panel body section and the first flange section of the first panel member.

8. A panel joint structure comprising:
a first panel member comprising a side wall, a first flange, and a load transmission section disposed between the side wall and the first flange;
a second panel member that is arranged to oppose the first flange; and
an adhesive that adheres the first flange to the second panel member,
wherein the load transmission section comprises a bead, and an internal space of the bead is filled with the adhesive.

9. The panel joint structure according to claim 8, wherein the bead comprises a pair of vertical walls coupled by an inclined surface.

10. The panel joint structure according to claim 9, wherein the inclined surface is inclined towards the first flange.

11. The panel joint structure according to claim 10, wherein the inclined surface comprises two slant sections inclined in opposite directions to form a ridgeline.

12. The panel joint structure according to claim 10, wherein a first angle defined by the side wall and the inclined surface is greater than a second angle defined by the side wall and the first flange.

13. The panel joint structure according to claim 8, further comprising:
a joint section that joins the first flange section and the second panel member in a state where the first flange section and the second panel member contact each other.

14. The panel joint structure according to claim 13, wherein, in a short direction of the first flange, a flange distal end-side end-portion of the load transmission section is disposed in a region between a corner section-side end-portion of the joint section and a flange distal end-side end-portion of said joint section.
